(19) United States
(12) Patent Application Publication
(10) Pub. No.: US 2011/0007517 A1
(43) Pub. Date: Jan. 13, 2011

(54) LICENSE PLATE LAMP

(76) Inventor: Li-Hong Chien, Lujhou City (TW)

Correspondence Address: Muncy, Geissler, Olds & Lowe, PLLC, 4000 Legato Road, Suite 310, FAIRFAX, VA, 22033, US

(21) Appl. No.: 12/500,098

(22) Filed: Jul. 9, 2009

(51) Int. Cl. B60Q 1/56

(52) U.S. Cl. 362/497

(57) ABSTRACT

A license plate lamp is installed in a license plate device to illuminate a car-use license plate and is assembled by a heat dissipation device, a circuit board and a shade. The circuit board is electrically connected with light emitting elements and is locked with the circuit board. As two ends of the shade are extended respectively with locking elements, the shade can be locked with the circuit board to form the license plate lamp. Furthermore, because having a fastening spring leaf, the shade can be first positioned in the license plate device, and then the entire license plate lamp is fixed and locked with the license plate device by fastening elements on the circuit board. Therefore, a life time of usage of the license plate lamp can be extended by the heat dissipation device and the license plate device can be prevented from melting down by high temperature.

### BACKGROUND OF THE INVENTION

a) Field of the Invention

The present invention relates to a license plate lamp, and more particularly to a license plate lamp which is provided with a heat dissipation effect.

b) Description of the Prior Art

In general, when a car is driving at night, a rear license plate will be illuminated following activation of an illumination system, and most of the license plate illumination devices are provided above the license plates to illuminate downward that an illumination area can be increased. Whereas, for the license plate illumination device on an existing market, a lamp is directly assembled in the license plate illumination device and a front end of the lamp is installed with a lamp shape. However, as most of the license plate illumination devices are made primarily by a plastic material; thus, when the lamp is energized to emit light, high temperature will be produced. In addition, as an interior of the license plate illumination device is a sealed space, air convection is unable to be formed, allowing internal temperature to be higher than the heat-resistant temperature of the plastic material. As a result, it is easy to melt down and deform the license plate illumination device under a long time of usage; therefore, the license plate illumination device should be replaced.

Accordingly, how to solve the aforementioned issues and shortcomings of the prior art is to be researched and developed for improvement by the present inventor and related vendors.

### SUMMARY OF THE INVENTION

The primary object of the present invention is to provide a license plate lamp which is installed in a license plate device to illuminate a car-use license plate, and which is assembled primarily by a heat dissipation device, a circuit board and a shade. The circuit board is electrically connected with plural light emitting elements (such as Light Emitting Diode (LED)) and is locked with the heat dissipation device. As two ends of the shade are extended respectively with fixing elements, the shade can be locked with the circuit board to form the license plate lamp. Furthermore, because the shade is provided with a fastening spring leaf, the shade can be positioned in the license plate device first, and then the entire license plate lamp is fixed and locked at the license plate device by fastening elements on the circuit board. Accordingly, a lifetime of usage of the license plate lamp can be extended by the heat dissipation device and the license plate device can be prevented from melting down due to high temperature.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional schematic view of a preferred embodiment of the present invention.

FIG. 2 shows a three-dimensional exploded view of a preferred embodiment of the present invention.

FIG. 3 shows a schematic view of the present invention when assembling a heat dissipation device and a circuit board.

FIG. 4 shows a schematic view of the present invention when assembling a circuit board and a shade.

FIG. 5 shows a schematic view of the present invention when assembling a license plate lamp and a license plate device.

FIG. 6 shows a cutaway view of a usage state of a preferred embodiment of the present invention.

### DETAILED DESCRIPTION OF THE PREFERRED EMBODIMENTS

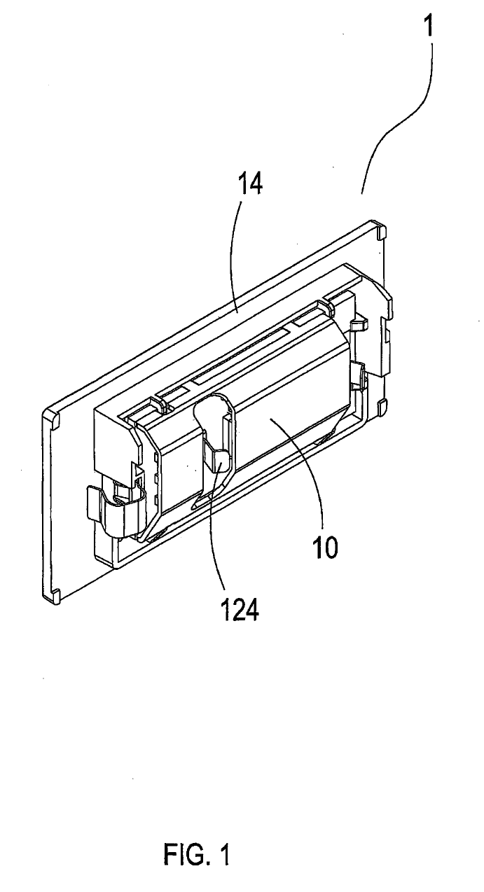

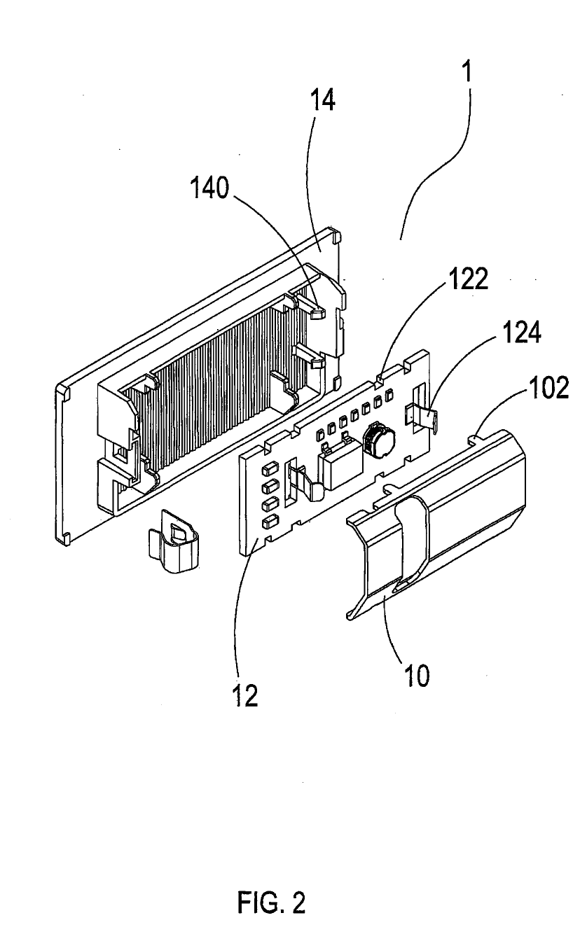

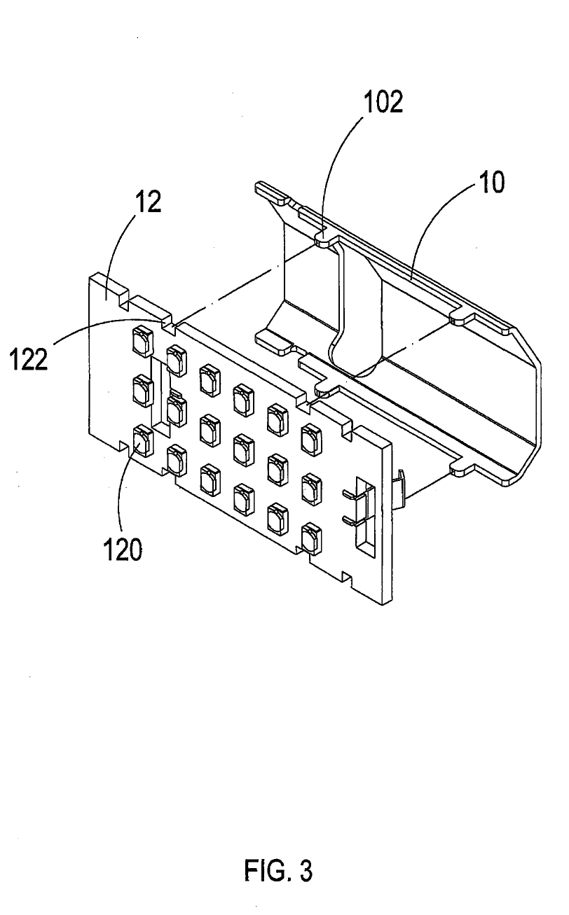

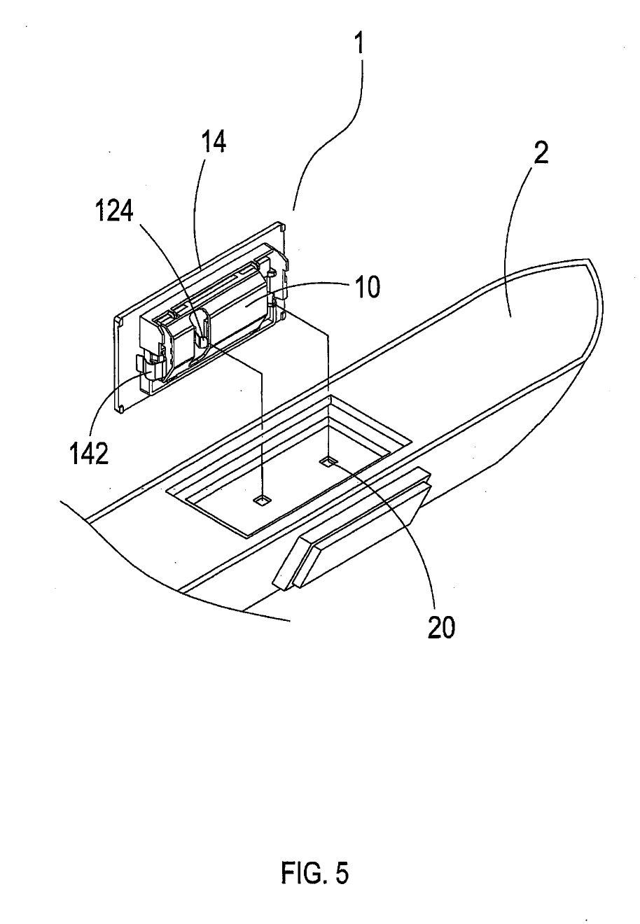

Referring to FIG. 1 and FIG. 2, it shows a three-dimensional schematic view and a three-dimensional exploded view of a preferred embodiment of the present invention. As shown in the drawings, the present invention is a license plate lamp, and referring to FIG. 3 at a same time, the license plate lamp 1 comprises primarily a heat dissipation device 10, a circuit board 12 and a shade 14 (transparent or semi-transparent). The circuit board 12 is electrically connected with plural light emitting elements 120 (such as LED), and peripheries of the circuit board 12 are formed with plural fastening parts 122 which can correspond to and be locked with plural tenons 102 extended from peripheries of the heat dissipation device 10, allowing the heat dissipation device 10 to be assembled with the circuit board 12. On the other hand, locations on the circuit board 12, departing from the light emitting elements 120 and corresponding to fastener holders 20 (as shown in FIG. 5), are provided with fastening elements 124; and the circuit board 12 can be fixed at a pre-determined position through the fixing elements 140 which are extended respectively from two ends on the shade 14. Accordingly, by the aforementioned structures, the license plate lamp 1 described above is accomplished.

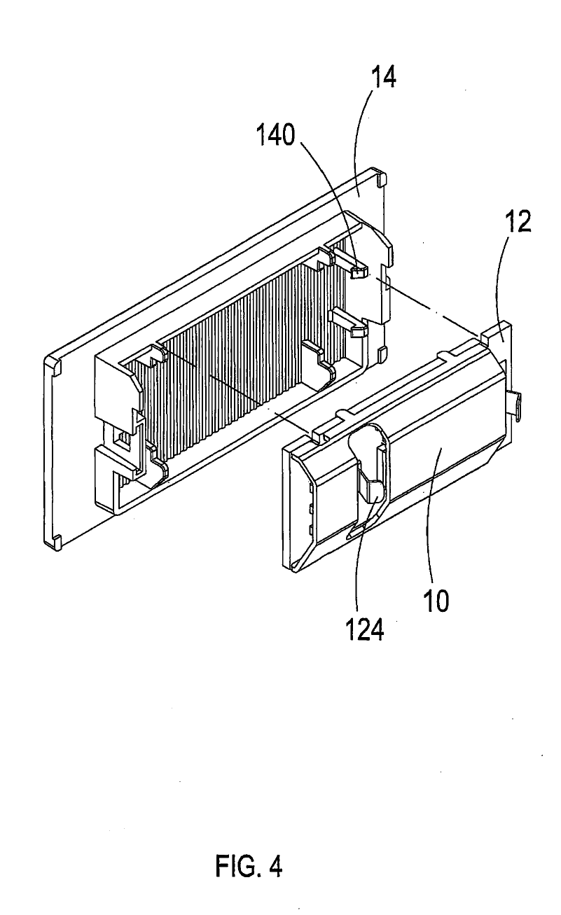

Referring to FIGS. 3 to 5 at a same time, it shows a schematic view of the present invention when assembling a heat dissipation device and a circuit board, a schematic view of the present invention when assembling a circuit board and a shade, as well as a schematic view of the present invention when assembling a license plate lamp and a license plate device. As shown in the drawings, first, the plural fastening parts 122 formed at the peripheries of the circuit board 12 are locked with the plural tenons 102 extended from the peripheries of the heat dissipation device 10, allowing the heat dissipation device 1 to be assembled with the circuit board 12. After accomplishing the aforementioned assembling, the circuit board 12 is installed on the shade 14. As the two ends of the shade 14 are extended respectively with the fixing elements 140, the circuit board 12 can be fixed at a pre-determined position by the fixing elements 140. At this time, the light emitting elements 120 on the circuit board 12 will face toward the shade 14. In addition, as the shade 14 is transparent, high transmittance can be achieved. After assembling the license plate lamp 1, a fastening spring leaf 142 provided at one side of the shade 14 is first abutted and positioned with a license plate device 2, and then the fastening elements 124 on the circuit board 12 are locked into the fastener holders 20 to achieve an object of fixing. Accordingly, by the aforementioned assembling structures, the entire assembly structures can be intensified.

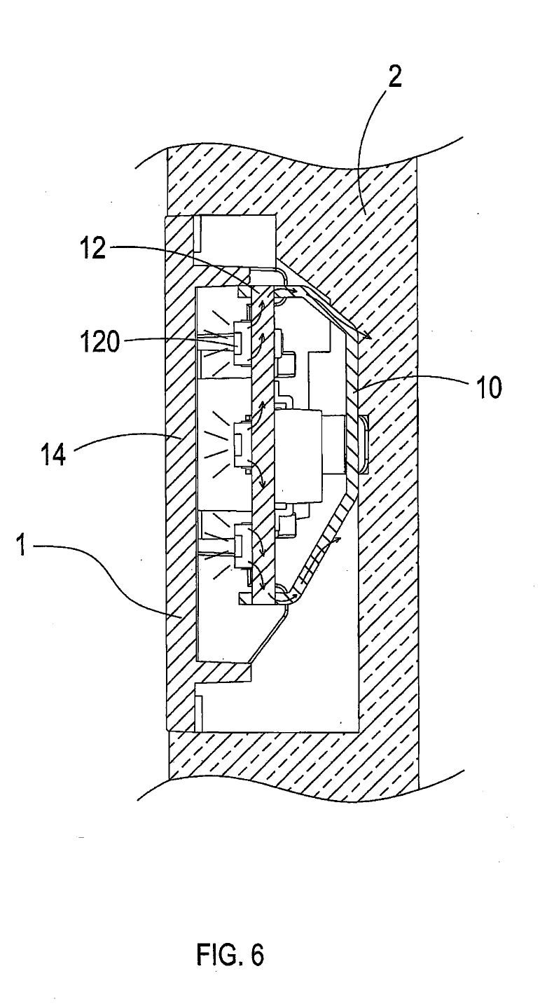

Referring to FIG. 6, it shows a cutaway view of a usage state of a preferred embodiment of the present invention. As shown in the drawing, after the license plate lamp 1 has been assembled with the license plate device 2, the circuit board 12 is connected to a power source having a positive electrode and a negative electrode to be electrically connected. At this time, the light emitting elements 120 on the circuit board 12 emit light by being energized and the light will face toward the shade 14. In addition, as the shade 14 is transparent, high transmittance can be achieved. On the other hand, heat energy which is generated after energizing the light emitting elements 120 can be transmitted through the heat dissipation device 10 to increase a heat dissipation effect. As a result, a life time of usage of the license plate lamp 1 can be extended by the heat dissipation device 10, and the license plate device 2 can be prevented from melting down due to high temperature.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A license plate lamp which is installed in a license plate device having plural locking elements, comprising:
a heat dissipation device, peripheries of which are extended with plural tenons;
a circuit board, which is electrically connected with plural light emitting elements and peripheries of which are formed with fastening parts at location corresponding to the tenons, with locations on the circuit board, departing from the light emitting elements, being provided with fastening elements corresponding to fastener holders; and
a shade, two ends of which are extended respectively with fixing elements to lock the circuit board.

2. The license plate lamp according to claim 1, further comprising a fastening spring leaf which is provided at a side of the shade and is abutted and positioned with the license plate device.

3. The license plate lamp according to claim 1, wherein the shade is further transparent or semi-transparent.

4. The license plate lamp according to claim 1, wherein the circuit board is electrically connected with a power source having a positive electrode and a negative electrode.

5. The license plate lamp according to claim 1, wherein the light emitting element is a light emitting diode.
